(19) United States
(12) Patent Application Publication
(10) Pub. No.: US 2008/0306765 A1
(43) Pub. Date: Dec. 11, 2008

(54) Method and Structure for Providing Medical Benefits to Retired Employees

(75) Inventors: William Daniels, Allison Park, PA (US); Michael Langan, Valhalla, NY (US)

Correspondence Address: KING & SPALDING LLP, 1180 PEACHTREE STREET, ATLANTA, GA, 30309-3521, US

(73) Assignee: Towers Perrin Forster & Crosby, Inc., Philadelphia, PA (US)

(21) Appl. No.: 12/134,327

(22) Filed: Jun. 6, 2008

Related U.S. Application Data
(60) Provisional application No. 60/933,559, filed on Jun. 6, 2007.

(51) Int. Cl. G06Q 50/00; G06Q 40/00

(52) U.S. Cl. 705/2; 705/40

(57) ABSTRACT

A method for providing post-retirement health-care benefits is provided. The method includes the steps of adopting a health reimbursement arrangement that includes a sponsor and a beneficiary, wherein the beneficiary is employed by the sponsor. A pension plan is adopted, wherein the pension plan includes an account. Funds are provided to the pension plan and the account while the beneficiary is employed by the sponsor. Funds are dispersed from the account to reimburse the beneficiary only for medical expenses. The funds are dispersed in response to determining that the beneficiary is no longer employed by the sponsor and that the medical expenses are qualified medical expenses.

### CROSS REFERENCE TO RELATED APPLICATIONS

This patent application claims priority under 35 U.S.C. § 119 to U.S. Provisional Patent Application No. 60/933,559, entitled “Funded HRA,” filed Jun. 6, 2007. The complete disclosure of the above-identified priority application is hereby fully incorporated herein by reference.

### FIELD OF THE INVENTION

This invention relates generally to the field of managing employee benefits, and more specifically to providing and managing health-care benefits that are provided to employees following termination of their employment.

### BACKGROUND OF THE INVENTION

Conventionally, employers use one of three approaches to provide retiree medical benefits to employees: conventional retiree medical plans, Health Savings Accounts, and notional Health Reimbursement Arrangements. Conventional employer provided retiree medical plans typically take the form of a commitment by the employer to provide employees who meet certain retirement eligibility conditions with post-employment health insurance coverage. The employer may provide the coverage through an insurance policy or through self-insurance. The benefit is provided as a tax-free benefit to employees under Internal Revenue Code (“IRC”) §§ 105 and 106. Generally speaking, IRC § 106 excludes the value of employer-provided coverage under an accident or health plan from employee's gross income. IRC § 105 excludes the value of services or reimbursements actually received under an accident or health plan from gross income.

Employers often continue to provide a retired employee with the health insurance coverage the employee held prior to retirement. From an accounting standpoint, employers who offer this type of benefit recognize an obligation for the accrued present value of the benefits expected to be paid in the future. The value of the benefits expected to be paid in the future increases relative to the cost of health care. This conventional type of commitment can be a significant cost burden to many employers. As a result, many organizations have reduced or eliminated such benefits.

Although employers have chosen to reduce retiree health care benefits because of cost concerns, these actions have workforce management implications. Employees will often postpone retirement for fear of losing retiree health insurance coverage. This can have adverse implications for an employer, including an increase in active employee health costs, a reduction in workforce productivity, compromised workplace safety, and frustrated succession plans. From an employer's perspective, the conventional approach for providing retiree health insurance coverage is no longer effective. Accordingly, employers need an affordable way to deliver such benefits to enable employees to retire at appropriate times.

In addition, the conventional approach often fails from an employee's perspective. Because many employers are not legally bound to continue providing conventional retiree health care benefits, the benefit has become unreliable. Many retirees have experienced the reality that these employers can reduce or eliminate the benefits, forcing the retiree to obtain other coverage, which can create a hardship for the retiree. Accordingly, employees need reliable resources to effectively plan for their medical needs in retirement.

An alternative conventional approach that employers use to help employees accumulate funds to pay for health expenses in retirement is through Health Savings Accounts (HSA). HSAs are authorized under IRC § 223 and permit employees and employers to make contributions to individual employee accounts where the employer contributions are not taxable income to the employee, investment income earned on the funds in the HSA is not taxed, and distributions are tax-free if the distribution is used to reimburse the employee for eligible medical expenses. As an employer-provided retiree medical plan, however, HSAs have many shortcomings.

First, funds in an HSA are owned by the HSA account holder and thus are available for distribution for any purpose (not just for eligible medical expenses) and at any time (not just upon termination of employment). If an employee withdraws funds from an HSA for a purpose other than eligible medical expenses, the withdrawal is generally subject to income and penalty taxes. Consequently, an employer's contributions to an HSA can be withdrawn and used for something other than a retiree's health-care expenses. Thus, the employer cannot be certain of achieving its objective of providing for an employee's health care after retirement.

Second, funds in an HSA are always 100% vested in the account holder. Thus although an employer may make contributions to an HSA, the employer cannot subject those contributions to delayed vesting requirement—common in other retirement benefits such as IRC § 401(k) plans—that might encourage employee retention.

Third, in order for an employee to be eligible to receive tax-free employer contributions to an HSA, the employee must be enrolled in a High Deductible Health Plan (HDHP) that meets statutory requirements and generally have no other current health benefit coverage. Many employers do not wish to make such changes in their active health plans and, even if they do, many employees may fail to qualify for an HSA due to health insurance coverage extended from a working spouse's plan.

A third conventional approach that employers can use to provide retiree medical benefits is a retiree-only Health Reimbursement Arrangement (HRA). Internal Revenue Service (“IRS”) Notice 2004-45 confirms the tax-favored status of HRAs, which allow employers to establish accounts to be used by the employee for reimbursement of medical expenses, whether funded or notional (i.e., unfunded). IRS guidance also allows an employer to state that benefits are unavailable to a participant until retirement from the employer. Under conventional notional HRA-based plans, the amount in an employee's account is a fixed amount such as, for example, $2,000 for each year of service, which is credited to the employee's HRA. The balance is carried over from year to year and is reduced by any reimbursements to the retiree until the account is exhausted.

HRAs have the advantages of a fixed employer cost that is not related to health care inflation and that the benefits are not taxable income to retirees. However, conventional HRA plans have several disadvantages. First, employers must record a balance sheet obligation for the present value of the accounts, which can vary based on changes in rates of returns on high quality, fixed income investments.

Second, employees generally do not appreciate the plans, primarily because the benefit is not tangible. Because there are generally no assets in trust to support the employer's promise to pay the medical benefits, balances in individual accounts may receive little or no interest growth. Further, the security of the accounts is at risk. Should an employer who sponsors such a plan enter bankruptcy, an employee's claim to the plan benefits is that of a general creditor, and the employee may never receive the benefit.

Some employers have implemented a variation of the HRA whereby contributions are made to a tax-qualified trust in support of the fixed annual credit provided for by an HRA. These arrangements provide all of the desired tax and benefit security attributes of the present invention but only for employees of not-for-profit employers or for collectively-bargained employees.

Accordingly, a need exists for an alternative retiree health care plan structure that enables employers to support the payment of retiree health care related expenses for all employees. A further need exists for the benefits paid from the plan to be tax-free to the retiree, and for the funds to be fully secured so that employees can count on receiving benefits regardless of their employer's future financial condition.

### SUMMARY OF THE INVENTION

The present invention satisfies the above-identified needs by providing a method for providing post-retirement health-care benefits. A health reimbursement arrangement including a sponsor and at least one beneficiary is adopted. A pension plan is adopted wherein the pension plan includes an account. Funds are provided to the pension plan and the account while the beneficiary is employed by the sponsor. Funds from the account are dispersed to the beneficiary only for medical expenses incurred after the beneficiary's employment with the sponsor is terminated.

In another aspect, a financial structure for a funded health reimbursement arrangement is provided. The structure includes a pension plan that includes an account, wherein funding for the pension plan and the account are received only from a sponsor, and wherein the health reimbursement arrangement comprises withdrawal conditions. The withdrawal conditions include the condition that funds from the account cannot be withdrawn until the beneficiary is no longer employed by the sponsor. The withdrawal conditions also include the condition that funds from the account cannot be withdrawn except to reimburse the beneficiary for medical expenses incurred by the beneficiary.

In yet another aspect of the present invention, a method for assisting an employer in providing post-retirement health benefits to its employees is provided. The employer is advised to sponsor a health reimbursement arrangement wherein the employees are beneficiaries of the health reimbursement arrangement. The health reimbursement arrangement includes implementing a pension plan, wherein the pension plan includes an account. The health reimbursement arrangement also includes providing funds to the pension plan and the at least one account by the employer. The health reimbursement arrangement also includes dispersing funds from the account to a beneficiary to reimburse a medical expense of the beneficiary upon satisfaction of withdrawal conditions.

Additional aspects, objects, features, and advantages of the invention will become apparent to those having ordinary skill in the art upon consideration of the following detailed description of exemplary embodiments. For a more complete understanding of the exemplary embodiments of the present invention and the advantages thereof, reference is now made to the following description in conjunction with the accompanying drawings described below.

### BRIEF DESCRIPTION OF THE DRAWINGS

FIG. 1 is a block diagram depicting a representative structure of a funded health reimbursement arrangement according to an exemplary embodiment of the present invention.

FIG. 2 is a flowchart depicting a method for using the health reimbursement arrangement of FIG. 1 to fund and disperse health benefits to retirees according to an exemplary embodiment of the present invention.

FIG. 3 is a flowchart depicting a method for verifying a dispersal request and dispersing funds in the health reimbursement arrangement of FIG. 1 according to an exemplary embodiment of the present invention.

FIG. 4 is a block diagram depicting a representative structure of a funded health reimbursement arrangement according to an alternative exemplary embodiment of the present invention.

### DETAILED DESCRIPTION OF EXEMPLARY EMBODIMENTS

Certain features of the exemplary embodiments of the present invention are described with respect to laws of the United States, and regulations and notices set forth by government agencies, including the Internal Revenue Service. A person of ordinary skill in the art would understand that references to laws, regulations, and notices by number or section are made for convenience and clarity, and should any laws, regulations, and notices be promulgated under different numbers or sections, those new numbers and sections fall within the scope of the present invention. Furthermore, a person of ordinary skill in the art would understand that code sections and regulations are amended from time to time. One of ordinary skill in the art would understand that the invention described herein can be modified to conform to the amendments, and such modifications are within the scope of the invention. Moreover, the exemplary embodiments of the present invention are described in terms of employer-sponsored plans that contain individual accounts for each employee of the employer sponsoring the plans. One of ordinary skill in the art would understand that the exemplary embodiments apply equally for an employer with one employee or for an employer with many employees.

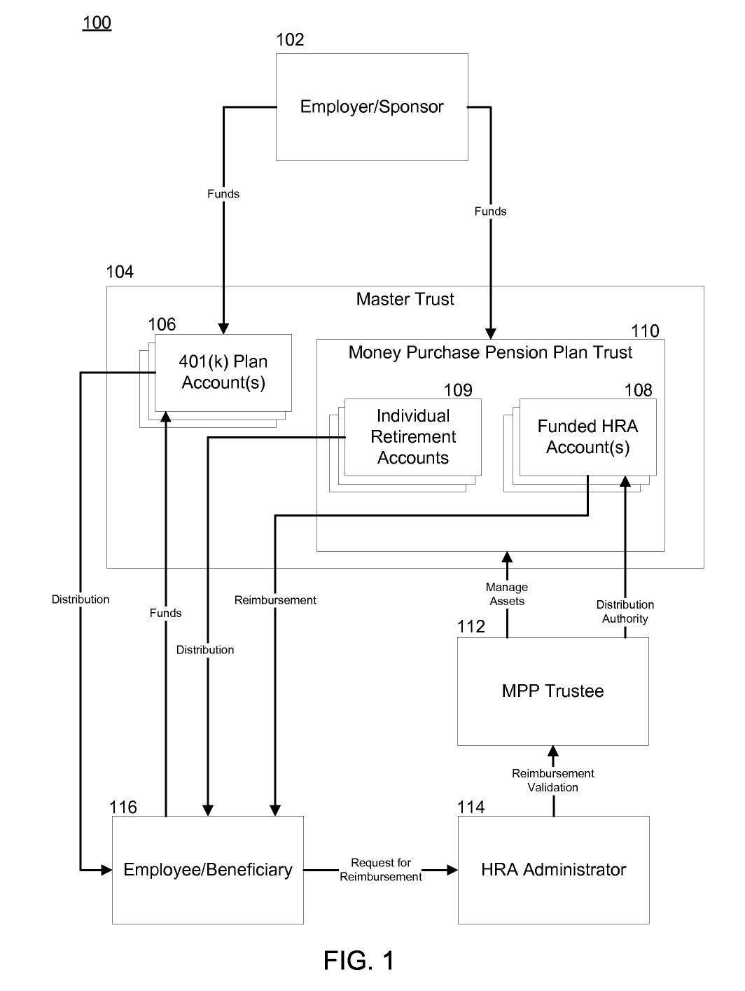

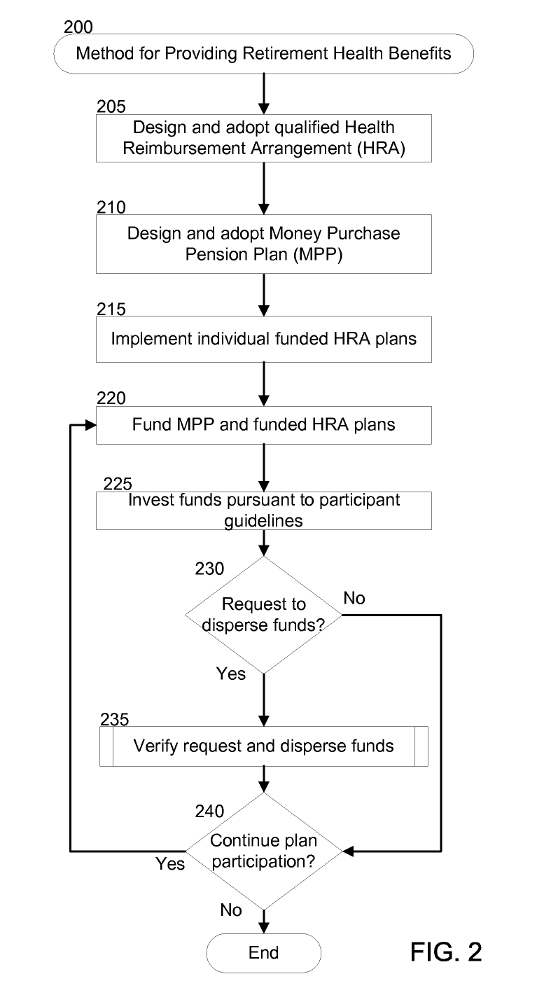

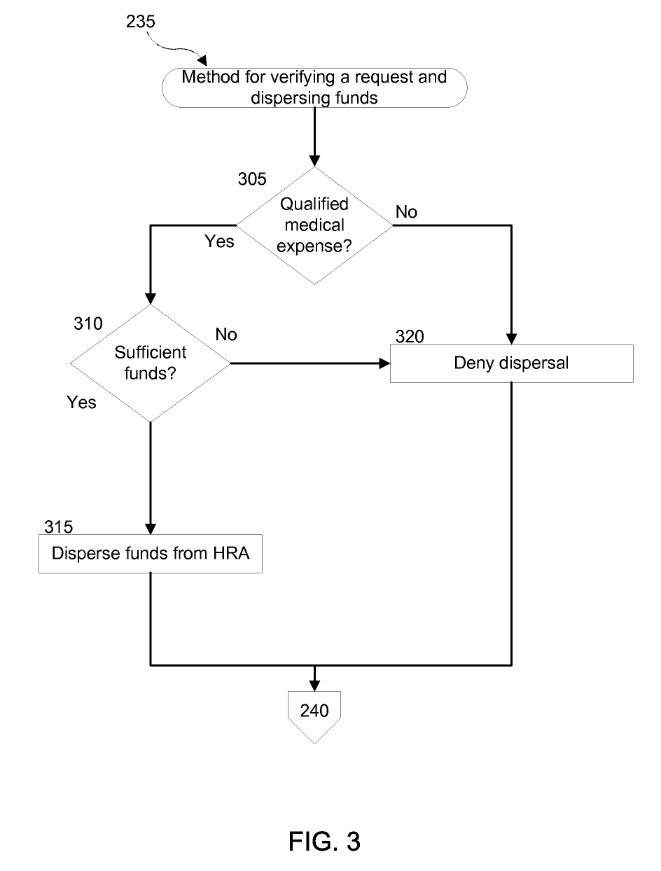

Referring now to the drawings, in which like numerals represent like elements, aspects of the exemplary embodiments will be described. FIG. 1 is a block diagram depicting a representative structure 100 of a funded health reimbursement arrangement (“funded HRA”) according to an exemplary embodiment of the present invention. FIG. 1 will be described in more detail with respect to the methods described in FIGS. 2 and 3.

FIG. 2 is a flowchart depicting a method 200 for using the health reimbursement arrangement of FIG. 1 to fund and disperse health benefits to retirees according to an exemplary embodiment of the present invention. The method 200 will be described with respect to FIGS. 1 and 2. Certain steps in the method 200 must naturally precede others for the invention to function as described. However, the invention is not limited to the order of the steps described if such order or sequence does not alter the functionality of the present invention. That is, it is recognized that some steps may be performed before, after, or in parallel with other steps without departing from the scope and spirit of the present invention.

Additionally, it is recognized that certain steps could be re-arranged in different sequences or entirely deleted without deviating from the scope and spirit of the invention. In other words, it is recognized that the steps illustrated in FIG. 2 represent one way of using the health reimbursement arrangement of FIG. 1 to fund and disperse health benefits. Other ways that may include adding different steps, eliminating steps, or a combination of eliminating steps and adding different steps will be apparent to one of ordinary skill in the art. Furthermore, while the steps are described in terms of actively performing each step, the acts of an individual or entity advising, directing, counseling, or inducing another individual or entity to perform the steps are also within the scope of the present invention.

Employers and employees often find it desirable for an employer to provide its employees with health care benefits after the employee retires. In many workplaces, employers provide a promise to employees that, if the employee meets certain eligibility requirements (e.g., reaching a certain age or working for the employer for a certain number of years), the employer will provide assistance with health care costs after retirement.

The structure 100 illustrated in FIG. 1 allows an employer (also referred to as a sponsor”) 102 to sponsor an HRA plan that allows the employer 102 to make tax deductible contributions to a funded HRA account 110 that funds such promised benefits. The funded HRA is created when the employer 102 deposits tax-qualified trust assets in the amount promised in the HRA in individual participant accounts. This structure provides the ability to invest assets as can occur in an IRC §401(k) (“401(k)”) plan.

The structure includes a master trust 104 that holds all of the separate trust accounts of the employer's 401(k) plan 106, as well as a Money Purchase Pension (MPP) plan 108 trust. The MPP 108 contains individual funded HRA accounts 110. In an exemplary embodiment, the MPP 108 is a single trust account that contains one funded HRA account 110 for each employee 116 who is to receive post-retirement health care benefits and also contains one retirement account 109 for each employee 116. In this embodiment, each employee's 116 benefits under the MPP 108 consists of a funded HRA account 110 and a retirement account 109. The total value of the funded HRA accounts 110 constitute a sub-account of the MPP 108. The total value of the individual retirement accounts 109 and the funded HRA accounts 110 constitute the entire assets of the MPP 108.

The MPP 108 is administered at least in part by an MPP trustee 112. The MPP trustee 112 is responsible for ensuring that the funds in the MPP 108 comply with any applicable laws and regulations, and for providing final approval for any distributions from the trust. Certain laws and regulations that can apply to trust operation will be described in further detail below. The MPP trustee 112 is also responsible for safekeeping of the MPP 108 assets. Under this embodiment, investment funds available within the MPP 108 would be the same as those within the 401(k) plan 106. Under an alternative embodiment, the MPP 108 funds can be different from the 401(k) plan 106. The selection of the funds can be the responsibility of the sponsor 102, or alternatively, any party to whom the sponsor 102 delegates that authority.

The funded HRA account 110 provides a beneficiary 116 with the ability to receive distributions from the funded HRA account 110 tax-free in retirement, so long as those distributions are used to reimburse the retired employee 116 for qualified medical expenses. In an exemplary embodiment, qualified medical expenses are those defined as “medical care” under IRC § 213(d), such as, but not limited to, services of a hospital or a licensed health care professional, prescription drugs, or non-prescription medicines that satisfy standards set by the IRS in Revenue Ruling 2003-102. In an alternative exemplary embodiment, qualified medical expenses may include reimbursements for premiums for insurance covering medical care expenses as defined in IRC § 213(d)(1)(D). To ensure that distributions are made only to reimburse qualified medical expenses, in an exemplary embodiment, the structure includes an HRA administrator 114 who reviews expenses submitted by plan beneficiaries for compliance with legal, regulatory, and plan guidelines. In an alternative exemplary embodiment, this task may be performed by the MPP trustee 112, the employer 102, or another individual or entity capable of determining whether a medical expense can be reimbursed. The determination of whether a medical expense can be reimbursed is described in further detail below with respect to FIG. 3.

Referring now to FIG. 2, in step 205 the employer 102 adopts an MPP 108 that includes an HRA. In an exemplary embodiment, the employer 102 sponsors a retirement HRA that is developed in accordance with the guidance provided in IRS Notice 2002-45 (“Notice 2002-45”), IRS Revenue Ruling 2002-41 (“Ruling 2002-41”) and IRS Revenue Ruling 2004-45 (“Ruling 2004-45”). The provisions of the HRA can be contained in the MPP 108 plan. If the retirement HRA follows these guidelines, it can provide benefits to employees before and after their termination from employment with the employer 102.

To qualify as a “retirement HRA,” the employer 102 includes a provision in the plan that restricts access by participants to the HRA funds to the period following termination of employment. The exemplary funded HRA can have several additional characteristics. First, accounts under the HRA are funded with employer 102 funds, rather than with employee 116 funds.

Second, funds deposited in employees' 116 funded HRA accounts 110 should satisfy the nondiscrimination standards set forth in IRC § 105(h) (“105(h)”). In an exemplary embodiment, funds satisfy 105(h) when deposits are a flat dollar amount for a given year. In an alternative exemplary embodiment, the flat dollar amount can vary based on one or more characteristics of the employee 116, such as, but not limited to, the employee's 116 age, years of service to the employer 102, or other characteristic that meets the non-discrimination standard of 105(h). In yet another alternative exemplary embodiment, the funds satisfy 105(h) when the amount of the funds is based on any characteristic of the employee 116 aside from a percentage of the employee's 116 pay.

Third, accruals in employees' 116 funded HRA accounts 110 should be an amount that is subordinate to the total value of the retirement benefits in the MPP 108. In an exemplary embodiment, the accruals are subordinate to the benefits in the MPP 108 if the sum of the employer's 102 contributions to the funded HRA accounts 110 of all participating employees 116 does not exceed twenty-five percent of the total contributions the employer 102 makes to the MPP 108 for all participating employees 116. In this embodiment, subordination is determined based on cumulative contributions over the life of the employer's 102 HRA plan. Accordingly, contributions to the funded HRA accounts 110 in a given year that are less than 25% of total contributions can be offset in later years by larger contributions to the funded HRA accounts 110 with respect to the MPP 108, so long as total cumulative contributions to the funded HRA accounts 110 do not exceed 25% of the total combined contributions to the MPP 108 and the employees' 116 funded HRA accounts 110. In an alternative exemplary embodiment, the accruals in the funded HRA are subordinate to the retirement benefits in the MPP 108 if the accruals comply with IRS Regulation § 1.401-14(c)(1)(i), or any other statute, regulation, notice, or ruling setting forth a definition of subordinate in the context of retiree health care benefits.

Fourth, funds deposited in an employee's 116 funded HRA account 110 are dispersed on a tax-free basis to the employee 116 (and the employee's beneficiaries) during the lifetime of the employee and the beneficiaries. Thus, in an exemplary embodiment, any unused funds revert back to the employer 102 upon the employee's 116 death. Under this embodiment, the funded HRA account 110 may be designed so that upon the death of the retired employee, funds remaining in the funded HRA account 110 may reimburse qualified medical expenses of the surviving spouse of the deceased retiree and the former dependents of the deceased retired employee. Fifth, in order for an employee 116 to be eligible to receive benefits under the funded HRA, the employer 102 should make contributions on the employee's 116 behalf to the MPP 108.

Referring again to FIG. 2, in step 210, the employer 102 adopts an MPP 108. In an exemplary embodiment, the MPP 108 plan is a defined contribution plan in accordance with IRC § 414(i) (“414(i)”). Under 414(i), a defined contribution plan is “a plan which provides for an individual account for each participant and for benefits based solely on the amount contributed to the participant's account, and any investment income, expenses, gains and losses, and any forfeiture of accounts of other participants which may be allocated to such participant's account.” MPP 108 plans (also referred to as “Annuity Plans”) are plans that accord with 414(i), other than profit sharing or stock bonus plans. Once established, an employer 102 can make contributions into MPP 108 plan accounts for its employees 116 in the same manner as the employer 102 might make non-elective contributions to a 401(k) plan.

In an exemplary embodiment, contributions to the MPP 108 are made under a “definitely determinable” formula. By way of example only, non-elective contributions to a plan such as a 401(k) plan are “definitely determinable.” In an exemplary embodiment, employers who already make non-elective contributions to a 401(k) plan can direct these contributions to the MPP 108. Redirecting non-elective contributions from a 401(k) plan to an MPP 108 plan can occur with little, if any, impact on the ultimate benefit provided to the employee 116.

In an exemplary embodiment, the MPP 108 assets are held by an MPP trustee 112. The MPP trustee 112 is responsible for custodial activities such as ensuring the contributions to (and distributions from) the MPP 108 comply with all applicable laws and regulations.

In step 215, the employer 102 implements funded HRA accounts 110 within the MPP 108. In an exemplary embodiment, the employer 102 creates one funded HRA account 110 for each employee 116. In an alternative exemplary embodiment, the employer 102 can create individual funded HRA accounts 110 only for key employees. In this alternative embodiment, any employees 116 not designated as “key” employees would share a single funded HRA account 110, and assets that are to provide benefits to each employee 116 are accounted for separately.

In an exemplary embodiment, the funded HRA accounts 110 comply with IRC § 401(h) (“401(h)”). 401(h) provides that “a pension or annuity plan may provide for the payment of benefits for sickness, accident hospitalization, and medical expenses of retired employees, their spouses and their dependents.” Each account receives assets from the employer 102 subject to the plan characteristics described above with respect to step 205.

The exemplary funded HRA account 110 can include several additional features that ensure compliance with 401(h). First, the cumulative benefits in the funded HRA account 110 are subordinate to the retirement benefits provided by the MPP 108. Subordination is described in detail above with respect to step 205, and, in an exemplary embodiment, the funded HRA account 110 is subordinate to the MPP 108 if the total contributions to all of the funded HRA accounts 110 within the MPP 108 receive less than 25% of the contributions to the MPP 108 as a whole.

Second, the assets that support the funded HRA account 110 assets, including distributions, investment earnings, and expenses are accounted for separately from MPP 108 assets. In an exemplary embodiment, the assets in the funded HRA account 110 are held in separate accounts from MPP 108 assets. In an alternative exemplary embodiment, the funded HRA account 110 assets and MPP 108 assets are stored in a single account, but funded HRA account 110 assets and MPP 108 assets are tracked and accounted for separately.

Third, the employer's 102 contributions to each funded HRA account 110 should meet the “reasonable and ascertainable” standard promulgated by the IRS. This is because IRS regulations provide that assets contributed by an employer 102 under a 401(h) plan should be an ordinary and necessary expense, and should not constitute “more than reasonable” compensation when added to other employee 116 compensation.

Further, contributions in any taxable year are tax deductible to the employer 102 only to the extent that they are less than one of two actuarial cost calculations: 1) an amount determined by distributing the remaining unfunded costs of past and current service credits over the remaining future service of each employee 116, or 2) 10% of the costs which would be required to completely fund such medical benefits. IRS rules concerning the tax deductibility of contributions provide calculations for determining the liability for such benefits. Actuarial assumptions are developed and applied to calculate the present value of the benefits expected to be paid. The present value of benefits to be paid yields a liability, the unfunded portion of which can be distributed over the remaining future service (option 1 above) or to which the 10% would be applied (option 2 above).

The tax-deductibility of a contribution to a funded HRA account 110, then, will depend primarily on three factors: the plan's vesting schedule, expected employee 116 termination rates, and the rate of future accruals in the plan. If the funded HRA contributions are fully and immediately vested, the full amount of any contribution is deductible as long as the plan provides that any forfeiture (which, as described above, is caused by the death of a participant, spouse and dependents prior to distribution of all funds in the funded HRA account 110) will be used to pay administrative expenses associated with the plan, or to help meet the employer's 102 contribution requirements.

On the other hand, if the plan uses a delayed vesting schedule (e.g., the plan requires the employee 116 to reach a certain age or provide the employer 102 with a certain number of years of service before the assets in the funded HRA vest in the employee 116), the contribution may not be fully and immediately deductible if the employer 102 expects that a substantial portion of the contribution will be forfeited. For example, if the plan's vesting schedule, considered in light of expected employee 116 turnover, may indicate that a contribution equal to the HRA accrual will exceed the future benefits expected to be paid to the participant, the full contribution may not be fully and immediately deductible.

The following formulas describe the actuarial calculations required to determine the maximum tax deductible contribution (MAX) for a given year under option 1 (i.e., an amount determined by distributing the remaining unfunded costs of past and current service credits over the remaining future service of each employee 116).

MAX=(ΣPVFB−Assets)/(ΣPVFN/Number of participants)

PVFB=The present value of future benefits for a participant. The summation occurs over all plan participants, whether active or retired.

Assets=The plan assets in the trust as of a valuation date.

PVFN=The present value of the future working lifetime of a participant. The summation occurs over all active plan participants.

$${PVFB}_{x} = {\sum }_{t = 0}^{RA - x} ( {{B}_{x} ( 1 + i )}^{t} + {\sum }_{s = 0}^{t} {A}_{x + s} ) \cdot {V}_{x + t} \cdot {}_{t}^{}{p}{}_{x}^{} \cdot {q}_{x + t} \frac{1}{{( 1 + i )}^{t}}$$

PVFBₓ=The present value of future benefits expected to be paid to participant at current age x attributable to past and future benefit accruals.

Bₓ=The account balance at the valuation date for participant age x.

Aₓ=The annual accrual rate for a participant at age x.

Vₓ=The participant's vested interest in the account balance at age x.

i=The expected investment return on a participant's account balance.

qₓ=The total rate of withdrawal from employment for an employee at age x.

$${p}_{x} = 1 - {q}_{x} . \\ {PVFN}_{x} = {\sum }_{t = 0}^{RA - X} ( {}_{t}^{}{p}{}_{x}^{} \cdot {q}_{x + t} \cdot \frac{1}{{( 1 + i )}^{t}} )$$

The above formula for the present value of future benefits assumes that a participant's vested interest in the account balance will be withdrawn prior to the death of the participant and beneficiaries, or alternatively, will be used to pay administrative expenses. In the event that there are no plan features to cause this outcome, an additional term is needed to account for the probability of this form of forfeiture.

Under option 2 (i.e., 10% of the costs which would be required to completely fund such medical benefits), the maximum tax deductible contribution for a given year (MAX) is as follows.

MAX=(ΣPVFB−Assets)·10%

In the event that the deductible contribution limit (MAX) under both option 1 and option 2 is less than the contributions actually made to the trust in a given year, the excess would not be currently deductible. Excess contributions may be deductible in subsequent years. The employer 102 may have to pay taxes on the non-deductible contributions until they are determined to be deductible. It is worth noting, however, that although a contribution in excess of the deductible limit may be made to the trust without disqualifying the plan, if the contribution results in the funded HRA accounts 110 exceeding the 25% subordination limit, the contribution would be a disqualifying event.

Fourth, in an exemplary embodiment, it should not be possible to use the assets in the funded HRA account 110 for any purpose other than paying retiree medical benefits. In an alternative exemplary embodiment, it may be possible to use funded HRA account 110 assets to pay administrative expenses related to retiree medical benefits. The HRA administrator 114 can ensure that any medical reimbursements qualify, and the MPP trustee 112 can ensure that the only use of funds, other than to reimburse retirees for medical expenses, is for administrative expenses related to retiree medical benefits.

Fifth, upon satisfaction of all liabilities under the plan, any unused assets in a funded HRA account 110 should be returned to the employer 102. Sixth, a separate account can be established and maintained for benefits payable to key employees. In an exemplary embodiment, a separate account is maintained for all employees 116, which assures satisfaction of this characteristic without need to distinguish “key” employees from other employees 116. In an alternative exemplary embodiment, a single account can be created for employees 116 not categorized as “key” employees, and assets supporting the benefits to be paid to these “non-key” employees 116 can be accounted for separately. In this embodiment, a key employee can be any employee who, during the plan year or any preceding plan year, was a key employee as defined under the rules of IRC §§ 416(i) and 419A(d)(3), such as, but not limited to, an officer that is paid more than $130,000 annually, a five-percent owner, or a one-percent owner who is paid more than $150,000 annually.

In step 220, the employer 102 funds the MPP 108 and the individual funded HRA accounts 110. In an exemplary embodiment, the accounts are funded in accordance with the account characteristics described above to ensure that the funded HRA account 110 remains subordinate to the MPP 108, and to further provide that the contributions are immediately and fully deductible if the employer 102 so desires. In step 225, the funds in the MPP 108 and the funded HRA accounts 110 are invested pursuant to the directives of the participant.

In step 230, it is determined whether a request has been made for the dispersal of funds from a funded HRA account 110. If the determination in step 230 is negative, the method follows the “No” branch to step 240. If, on the other hand, the determination in step 230 is affirmative, the method follows the “Yes” branch to step 235. In step 235, the request for dispersal is verified, and, if the request can be met, funds are dispersed. Step 235 will be described in additional detail below with respect to FIG. 3.

In step 240, it is determined whether the plan participation should continue. If the determination in step 240 is affirmative, the method follows the “Yes” branch to step 220. If the determination in step 240 is negative, the method follows the “No” branch and ends.

FIG. 3 is a flowchart depicting a method for verifying a dispersal request and dispersing funds in the health reimbursement arrangement of FIG. 1 according to an exemplary embodiment of the present invention. The method will be described with respect to FIGS. 1, 2, and 3.

Referring now to FIG. 3, in step 305 it is determined whether the plan beneficiary 116 has made a request for reimbursement that can be reimbursed under the funded HRA plan. In an exemplary embodiment, determining whether a request can be reimbursed involves determining that any dispersal complies with the withdrawal conditions of a retirement HRA. As described above with respect to FIGS. 1 and 2, the withdrawal conditions can include, but are not limited to ensuring that the beneficiary 116 has been terminated from employment from the employer 102, and that the funds are being used to reimburse qualified medical expenses.

In an exemplary embodiment, the HRA administrator 114 who is responsible for making this determination receives a request from a beneficiary 116 to reimburse medical expenses the beneficiary 116 has incurred. If the HRA administrator 114 determines that the expenses can be reimbursed under the HRA plan, the HRA administrator 114 informs the MPP trustee 112 that a valid reimbursement request has been made. The method then follows the “Yes” branch to step 310, wherein it is determined if sufficient funds are available to satisfy the reimbursement. If the determination in step 310 is affirmative, the method follows the “Yes” branch to step 315. In step 315, funds from the beneficiary's 116 funded HRA account 110 are dispersed to the beneficiary 116 in an amount sufficient to reimburse the medical expense. In this embodiment of the present invention, funds from the funded HRA account 110 are dispersed tax free to the beneficiary 116. Referring again to step 310, if, on the other hand, it is determined that sufficient funds are not present in the funded HRA account 110, the method follows the “No” branch to step 320, wherein the dispersal is denied.

Referring again to step 305, if, on the other hand, it is determined that the funds do not qualify for reimbursement from the funded HRA, the method follows the “No” branch to step 320, wherein dispersal from the funded HRA account 110 is denied. The beneficiary 116 is not without options, however, if the dispersal is denied. The method then returns to step 235 of FIG. 2.

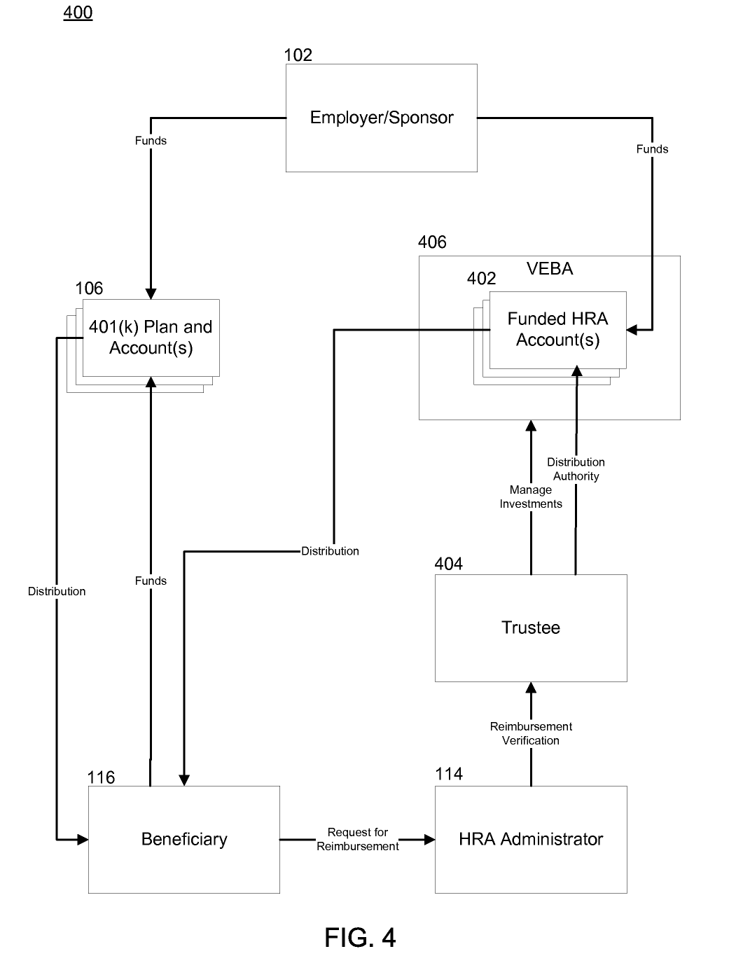

FIG. 4 is a block diagram depicting a representative structure of a funded health reimbursement arrangement according to an alternative exemplary embodiment of the present invention. The alternative embodiment described in FIG. 4 is similar to the embodiment described in FIG. 1, with the removal of the MPP 108 trust which contained the funded HRA accounts 110. Because the MPP 108 has been removed, the interaction among the entities of FIG. 4 changes with respect to FIG. 1.

In the alternative exemplary embodiment, the funded HRA account 402 is an account that complies with IRC § 501(c)(9) (“501(c)(9)”), also known as a VEBA account. Because the funded HRA account 402 is a 501(c)(9) account, the employer 102 should either be a not-for-profit company or the beneficiaries should have a collective bargaining arrangement with a for-profit company, otherwise the investment earnings of the trust may be taxable.

The funded HRA account 402 is created through having tax-qualified trust assets in individual participant separate accounts that equal the benefits promised in the HRA. This plan structure provides an employee 116 with the ability to direct the investment of account assets as would occur in a 401(k) plan. The funded HRA account 402 provides the ability for an employee 116 to receive the funds tax-free in retirement.

The funded HRA account 402 of the alternative exemplary embodiment is created in a similar manner to the funded HRA account 110 described in FIG. 1. First, the employer 102 adopts a retirement HRA and a VEBA 406. The funded HRA accounts 402 in this embodiment have several similar characteristics with respect to the funded HRA accounts 110 of FIG. 1.

First, the funded HRA accounts 402 are funded only with employer 102 funds. Second, accruals in employees' 116 funded HRA accounts 402 should satisfy the nondiscrimination standards under IRC § 105(h), as described above. Third, tax-free reimbursement of eligible medical expenses may be made to the former employee 116, spouse, and dependents, but assets remaining in the account upon the last death of the beneficiaries are forfeited. These three characteristics are similar to those described above with respect to FIG. 1. However, because the funded HRA account 402 of the alternative embodiment does not include the use of an MPP 108, the alternative exemplary funded HRA account 402 does not include a subordination requirement. Like the 401(h) accounts of the embodiment described in FIG. 1, the employer 102 in the alternative exemplary embodiment may adopt an IRC §501(c)(9) trust that provides for the creation of individual separate accounts for each participant to support the HRA accrual.

In yet another alternative exemplary embodiment, the alternative exemplary structure described in FIG. 4 may be used by a for-profit employer 102 to provide post-retirement health benefits to its non-collectively bargained employees 116. However, using the structure of FIG. 4 with a for-profit employer 102 can have negative tax implications.

Specifically, the investment earnings on trust assets are not tax-free. Rather, the earnings on the trust assets are subject to Unrelated Business Income Tax (UBIT), which is paid by the trust 104. This alternative exemplary embodiment may be used by for-profit employers who desire to implement a funded HRA account 110 as described above with respect to FIG. 1, but are unable for whatever reason to create an MPP 108. Aside from the tax downside, the alternative exemplary embodiment operates similarly to the structure described in FIG. 4.

IRC §§ 419 and 419A and corresponding IRS regulations provide guidance with respect to the tax-deductible contributions to IRC § 501(c)(9) trusts by employers. IRC § 419A(c)(2) (“419(c)(2)”) provides that the tax-deductible employer contribution in any year may include a reserve funded over the working lives of the covered employees 116 and actuarially determined on a level basis (using assumptions that are reasonable in the aggregate) as necessary for post-retirement medical benefits to be provided to current employees 116. The IRS, in Private Letter Ruling 9522054, approved the aggregate actuarial cost method (as described above with respect to FIG. 2) as an appropriate method to use to determine the amount of tax-deductible contributions for this embodiment. In the event that a contribution is made that exceeds the tax-deductible limit, the non-deductible portion is eligible for deduction in subsequent years. Unlike the structure described with respect to FIG. 1, no excise tax applies to non-deductible contributions to a 501(c)(9) trust.

Although specific embodiments of the invention have been described herein in detail, the description is merely for purposes of illustration. The exemplary methods described herein are merely illustrative and, in alternative embodiments of the invention, certain steps can be performed in a different order, performed in parallel with one another, or omitted entirely, and/or certain additional steps can be performed without departing from the scope and spirit of the invention. Additionally, various modifications of, and equivalent steps corresponding to, the disclosed aspects of the exemplary embodiments, in addition to those described herein, can be made by those skilled in the art without departing from the spirit and scope of the invention defined in the following claims, the scope of which is to be accorded the broadest interpretation so as to encompass such modifications and equivalent structures.

What is claimed is:

1. A method for providing post-retirement health-care benefits, comprising the steps of:
adopting a health reimbursement arrangement comprising a sponsor and a beneficiary, wherein the beneficiary is employed by the sponsor;
adopting a pension plan comprising an account;
providing funds to the pension plan and the account while the beneficiary is employed by the sponsor; and
dispersing funds from the account to reimburse the beneficiary only for medical expenses incurred after the beneficiary's employment with the sponsor is terminated.

2. The method of claim 1, wherein the dispersing step comprises the steps of:
determining whether the beneficiary is employed by the sponsor;
determining whether the medical expenses are qualified medical expenses; and
dispersing funds in response to determining that the beneficiary is no longer employed by the sponsor and that the medical expenses are qualified medical expenses.

3. The method of claim 2, wherein the determining steps are performed by a health reimbursement arrangement administrator.

4. The method of claim 1, wherein the account comprises an IRC § 401(h) account.

5. The method of claim 1, wherein the pension plan is a money purchase pension plan.

6. The method of claim 1, wherein the account comprises one account for each beneficiary employed by the sponsor.

7. The method of claim 1, wherein the providing step comprises providing funds to the account and the pension plan such that the funding to the account is subordinate to the total funding to the pension plan.

8. The method of claim 7, wherein the funding to the account is subordinate to the funding to the pension plan if the sum of contributions to the account does not exceed 25% of the total contributions to the pension plan

9. A financial structure for a funded health reimbursement arrangement for a beneficiary comprising:
a pension plan comprising an account, wherein funding for the pension plan and the account are received only from a sponsor, and wherein the health reimbursement arrangement comprises withdrawal conditions, the conditions comprising:
funds from the account cannot be withdrawn until the beneficiary is no longer employed by the sponsor; and
funds from the account cannot be withdrawn except to reimburse the beneficiary for medical expenses incurred by the beneficiary.

10. The financial structure of claim 9, wherein the account comprises an IRC § 401(h) account.

11. The financial structure of claim 9, wherein the account comprises one account for each beneficiary.

12. The financial structure of claim 9, wherein the pension plan trust is a money purchase pension plan.

13. The financial structure of claim 9, wherein the sponsor funds the pension plan trust such that the account is subordinate to the pension plan trust.

14. The financial structure of claim 13, wherein the account is subordinate to the pension plan trust so long as funding for the account does not exceed 25% of the combined funding for the pension plan.

15. The financial structure of claim 9, further comprising an HRA administrator who verifies that the medical expenses meet the withdrawal conditions.

16. The financial structure of claim 9, further comprising a trustee who manages the assets of the pension plan trust.

17. A method for assisting an employer in providing post-retirement health benefits to its employees, comprising the steps of:
advising the employer to sponsor a health reimbursement arrangement for the employees, wherein the health reimbursement arrangement comprises:
implementing a pension plan, comprising a retirement account and a health reimbursement account;
providing funds to the pension plan and retirement account and the health reimbursement account by the employer; and
dispersing funds from the health reimbursement account to reimburse a medical expense of a beneficiary upon satisfaction of withdrawal conditions.

18. The method of claim 17, wherein the health reimbursement account comprises an IRC § 401(h) account.

19. The method of claim 17, wherein the pension plan comprises a money purchase pension plan.

20. The method of claim 17, wherein the satisfaction of the withdrawal conditions comprises the steps of:
establishing that the beneficiary is no longer employed by the employer; and
establishing that the medical expenses are qualified medical expenses.
